(19) United States
(12) Patent Application Publication
(10) Pub. No.: US 2009/0249187 A1
(43) Pub. Date: Oct. 1, 2009

(54) System and Method for Generating a Converted Workflow Extensible Markup Language File Associated with a Workflow Application

(75) Inventors: Christopher M. Morris, Centerville, IA (US); Michael A. DuRee, Independence, MO (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/055,944

(22) Filed: Mar. 26, 2008

(51) Int. Cl. G06F 17/00

(52) U.S. Cl. 715/234

(57) ABSTRACT

The illustrative embodiments described herein provide a method, apparatus, and computer program product for generating a converted workflow extensible markup language file associated with a workflow application, such as the Workflow application from CA®, Inc. In one illustrative embodiment, the process identifies a workflow extensible markup language file associated with a workflow in a workflow application. The workflow extensible markup language file has extensible markup language content. The process converts the extensible markup language content into a new format to form converted extensible markup language content. The process generates a converted workflow extensible markup language file having the converted extensible markup language content.

### BACKGROUND

Workflows may be used by organizations, individuals, and other entities to achieve a wide range of objectives. A workflow is a set of activities that are organized to achieve one or more objectives. Each of the set of activities may be performed by one or more actors. Examples of actors in a workflow include human beings, software applications, machinery, organizational departments, and any other entity capable of performing an activity or executing a process. One early example of a workflow includes the assembly line in which a linear series of workers each perform a task on a piece of equipment in order to achieve a final product, such as an automobile. Today, workflows are often used to process data. For example, data in a modern workflow may be manipulated, authenticated, or transmitted by one or more actors using a pre-defined flow of interconnected steps in order to achieve an intended goal of the workflow.

Workflows may also be used by a department within an organization to render services to individuals or other departments within the organization, as well as customers and clients of the organization to which the department belongs. For example, companies and other large organizations generally have employees and departments that operate as internal service providers that handle certain operations to provide services to other departments within an organization. With the proliferation of computer networks at companies, information technology (IT), information services (IS), and other departments are responsible for handling questions, problems, training, equipment change requests, a change in production, business-related activities, personnel issues, and issues of employees needing assistance with operating various data processing equipment within the organization, such as personal computers, printers, fax machines, copiers, personal digital assistants, and telephones. To notify the IT department of a problem or change request for a piece of equipment, an employee may call, e-mail, or otherwise notify the IT department to give notice of the issue or provide a general description of the problem. Although this example illustrates an IT department managing various issues for intra-organizational individuals and departments, such issues may also be managed by a servicing department for outside clients and customers, such as clients and customers that utilize a computer network and data processing equipment.

A set of activities are typically associated with the issue being reported to the IT department. For example, for a request from an employee to service the employee's personal computer, a set of tasks or processes may need to be performed, such as notifying a particular department via e-mail or requesting supervisory approval for the service to the employee's personal computer. In order to facilitate the execution of these activities, a ticket associated with the issue may be generated or opened. Upon generating or opening the ticket, one or more workflow instances associated with the ticket may be opened whose objective is to perform the set of activities. Returning to the example above, upon receiving a request from an employee to service the employee's personal computer, a ticket and an associated workflow instance may be opened in which the first activities include sending an e-mail to a supervisor in the IT department to request approval. Thus, workflows can automate a set of activities that are associated with the ticket that is generated or opened as a result of a request or other issue originating from an individual, department, or organization, thereby saving the time and labor associated with the manual execution of these activities.

In some workflow applications, such as Workflow from CA®, Inc. (hereinafter CA® Workflow), which was founded as Computer Associates International™, Inc., a workflow may be exported into an extensible markup language (hereinafter “XML”) file. The XML file into which the workflow is exported contains XML content that describes one or more parameters about the workflow. However, understanding the workflow based on the workflow's corresponding XML file can present substantial challenges. For example, parameters of the workflow, including but not limited to the number of nodes in the workflow, may be difficult to read or understand by looking at the XML code in the XML file. In this example, parameters of the workflow may be obscured by hundreds or thousands of XML commands that make finding and understanding the relevant parameters a difficult and time-consuming task.

The difficulty of understanding a workflow based on the corresponding XML file may be especially problematic in a development environment. For example, a developer may need to update a workflow in a production server environment that has been updated or otherwise changed in development server environment. Currently, a development must undertake the time-consuming task on the order of days, of taking manual notes of the changes made in the development server environment and then apply the changes recorded in the manual notes to the workflow in the production server environment. A developer has no way of quickly and accurately assessing relevant parameters in the workflow updated in the development server environment so that changes may be identified, understood, and implemented in the production server environment.

### SUMMARY

To alleviate the existing problems with utilizing workflow XML files that are associated with workflows in a workflow application, including facilitating human understanding of the workflow XML files by converting the content of the workflow XML files into another format, the illustrative embodiments described herein are directed to a data processing system and, in particular, to a method and system for generating a converted workflow extensible markup language file. More particularly, the illustrative embodiments are directed to a method, system, and computer-usable program code for generating a converted workflow extensible markup language file associated with a workflow application, such as the Workflow application from CA®, Inc. In one illustrative embodiment, the process identifies a workflow extensible markup language file associated with a workflow in a workflow application. The workflow extensible markup language file has extensible markup language content. The process converts the extensible markup language content into a new format to form converted extensible markup language content, thereby enabling a user to more easily read the content. The process generates a converted workflow extensible markup language file having the converted extensible markup language content. In one example, the converted extensible markup language file is a text file.

In one embodiment, the process displays the converted extensible markup language content on a graphical user interface in the new format. In one example of this embodiment, displaying the converted extensible markup language content on the graphical user interface in the new format may include displaying a number of nodes in the workflow.

In another embodiment, identifying the workflow extensible markup language file associated with the workflow in the workflow application includes receiving a user selection identifying the workflow extensible markup language file. In one example of the embodiment, the user selection is made in a dialog window, and at least one workflow parameter is displayed in the dialog window.

In another embodiment, the extensible markup language content includes a set of workflow parameters associated with the workflow. In this embodiment, converting the extensible markup language content into a new format to form the converted extensible markup language content may include converting at least one portion of the extensible markup language content that is associated with at least one workflow parameter in the set of workflow parameters into the new format. In one example of this embodiment, displaying the converted extensible markup language content on the graphical user interface in the new format may include displaying at least one workflow parameter on the graphical user interface in the new format. In one example, the set of parameters includes at least one of an input parameter, an output parameter, a modified date, a process definition identifier, a process name, a short name, a description, and a number of nodes in the workflow.

### BRIEF DESCRIPTION OF THE DRAWINGS

Illustrative embodiments of the present invention are described in detail below with reference to the attached drawing FIGS., which are incorporated by reference herein and wherein:

FIG. 1 is a pictorial representation of a network data processing system in which the illustrative embodiments maybe implemented;

FIG. 2 is a block diagram of a data processing system in which the illustrative embodiments maybe implemented;

FIG. 3 is a block diagram of a ticket servicing system in which the illustrative embodiments maybe implemented;

FIG. 4 is a diagram of a workflow with which the illustrative embodiments may be implemented;

FIG. 5 is a diagram of a system for generating a converted workflow extensible markup language file associated with a workflow application in accordance with an illustrative embodiment;

FIG. 6 is a graphical representation of an XML file in accordance with an illustrative embodiment;

FIG. 7 is a graphical representation of a dialog window in accordance with an illustrative embodiment;

FIG. 8 is a graphical representation of a dialog window in accordance with an illustrative embodiment;

FIG. 9 is a graphical representation of a converted XML file in accordance with an illustrative embodiment;

FIG. 10 is a flowchart illustrating a process for generating a converted workflow extensible markup language file associated with a workflow application in accordance with an illustrative embodiment; and

FIG. 11 is a flowchart illustrating a process for generating a converted workflow extensible markup language file associated with a workflow application in accordance with an illustrative embodiment.

### DETAILED DESCRIPTION OF THE DRAWINGS

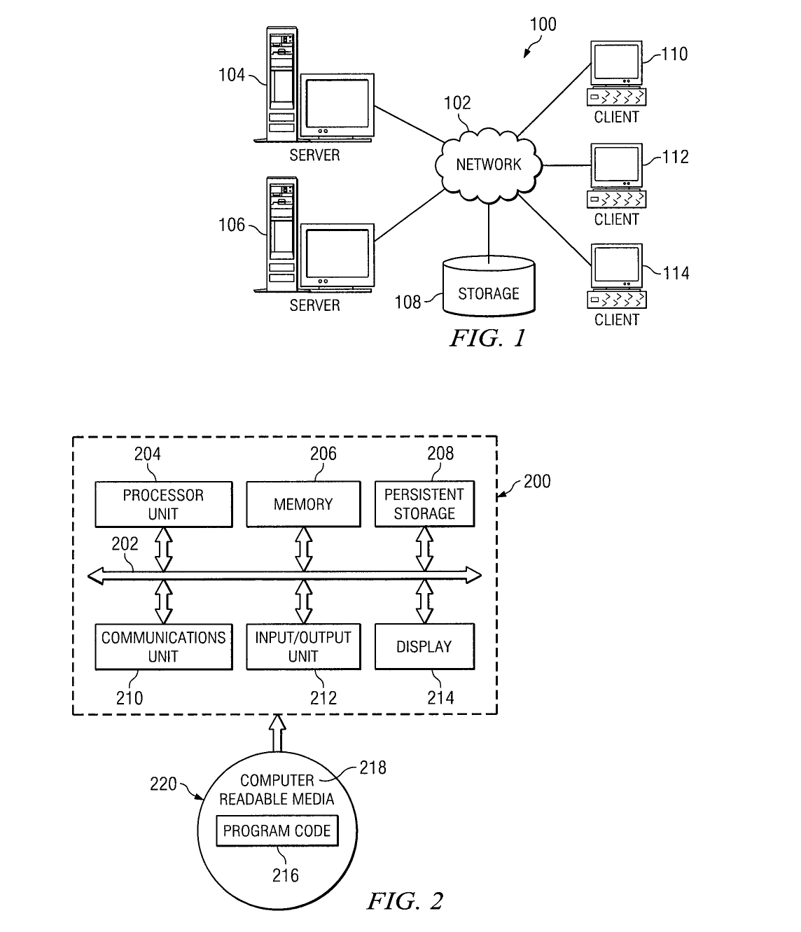

With reference now to the FIGS. and in particular with reference to FIGS. 1 and 2, exemplary diagrams of data processing environments are provided in which illustrative embodiments maybe implemented. It should be appreciated that FIGS. 1 and 2 are only exemplary and are not intended to assert or imply any limitation with regard to the environments in which different embodiments may be implemented. Many modifications to the depicted environments maybe made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Servers 104 and 106 may receive queries, such as service requests, from any of clients 110, 112, and 114 via network 102. Anyone of clients 110, 112, and 114 may also receive queries from other clients in clients 110, 112, and 114. Upon receiving such queries from clients 110, 112, and 114, a ticket servicing system on servers 104 and 106 that includes a service desk application, such as Unicenter® Service Desk may then be used to generate or open a ticket associated with the query from clients 110, 112, and 114. A workflow application, such CA® Workflow, on servers 104 and 106 may then initiate one or more workflow instances that address the query from clients 110, 112, and 114. The workflow application and service desk application may also be located on any of clients 110, 112, and 114. Servers 104 and 106 may also contain web services, such as Unicenter® web services or CA® Workflow web services, which are accessible to other servers and clients 110, 112, and 114. The workflow application may also be able to export workflows into XML files. In accordance with an illustrative embodiment, the content of the XML files may be converted into a new format that may be viewed by a user.

Clients 110, 112, and 114 are clients to server 104 in this example. Network data processing system 100 may include additional servers, clients, and other devices not shown. In one example, clients 110, 112, and 114 are data processing systems that are used by a respective customer, organization, department, employee, or other entity. In this example, each respective customer, organization, department, employee, or other entity may submit queries pertaining to any issue, including the servicing of clients 110, 112, and 114, to servers 104 and 106, another one of clients 110, 112, and 114, or any other data processing system that has a ticket servicing system. One or more of servers 104 and 106 and clients 110, 112, and 114 may also be part of an IT or IS department that services issues pertaining to each respective customer, organization, department, employee, or other entity. Storage 108 may contain data relating to the tickets and workflow instances associated with these issues.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of data processing system 200 is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 maybe a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive maybe used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer-implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 and may be loaded onto or transferred to data processing system 200 for execution by processor unit 204. Program code 216 and computer-readable media 218 form computer program product 220 in these examples. In one embodiment, computer program product 220 is a computer program product for generating a converted workflow extensible markup language file associated with a workflow application, such as CA® Workflow, in accordance with the illustrative embodiments.

In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive or a flash memory that is connected to data processing system 200. The tangible form of computer-readable media 218 is also referred to as computer recordable storage media.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that maybe present in communications fabric 202.

The illustrative embodiments described herein provide a computer-implemented method, apparatus, and computer program product for generating a converted workflow XML file associated with a workflow application, such as the Workflow application from CA®, Inc. A program is one or more executable computer programming statements, such as program code 216 in FIG. 2.

In one illustrative embodiment, the process identifies a workflow XML file associated with a workflow in a workflow application. The workflow XML file has XML content. The process converts the XML content into a new format to form converted XML content. The new format is any format into which the XML content of the XML file is converted.

The process generates a converted workflow XML file having the converted XML content. In one example, the converted XML file is a text file.

In one embodiment, the process displays the converted XML content on a graphical user interface in the new format. In one example of this embodiment, displaying the converted XML content on the graphical user interface in the new format may include displaying a number of nodes in the workflow. A node is a portion of a workflow that performs one or more activities that facilitate the objective of the workflow.

In another embodiment, identifying the workflow XML file associated with the workflow in the workflow application includes receiving a user selection identifying the workflow XML file. In one example of the embodiment, the user selection is made in a dialog window, and at least one workflow parameter is displayed in the dialog window. A workflow parameter is any attribute or data pertaining to the workflow. For example, a workflow parameter may be an input parameter, an output parameter, a modified date, a process definition identifier, a process name, a short name, a description, and a number of nodes in the workflow.

In another embodiment, the XML content includes a set of workflow parameters associated with the workflow. The set of workflow parameters includes one or more workflow parameters. In this embodiment, converting the XML content into the new format to form the converted XML content may include converting at least one portion of the XML content that is associated with at least one workflow parameter in the set of workflow parameters into the new format. In one example of this embodiment, displaying the converted XML content on the graphical user interface in the new format may include displaying at least one workflow parameter on the graphical user interface in the new format. The workflow parameter(s) may be chosen or defined by a user or data processing system.

In another embodiment, the workflow corresponding to the generated converted XML file having the new format may be a workflow that has been updated in a development server environment. This converted XML file may then be used by a developer to update a workflow in a production server environment. In another example, a separate converted XML file may be generated from a workflow in a production server environment and compared against the converted XML file generated from the updated workflow in the development server environment. Changes may then be made to the workflow in the production server environment based on this comparison.

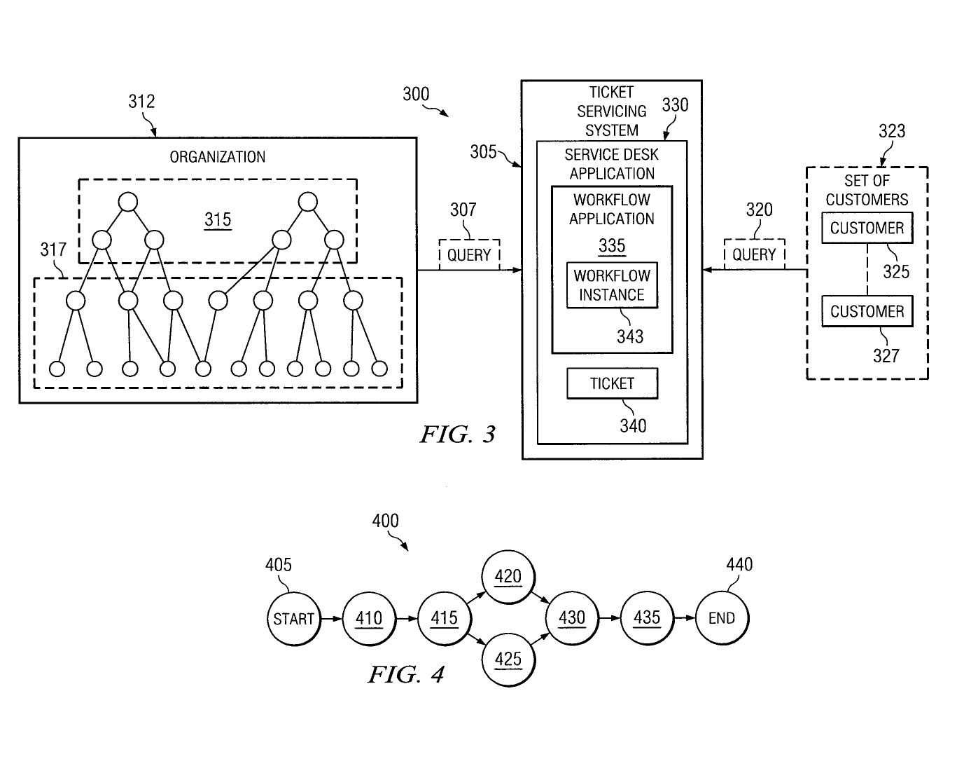

Turning now to FIG. 3, a block diagram of a ticket servicing system is depicted in which the illustrative embodiments may be implemented. Specifically, FIG. 3 shows data processing system 300, which contains components that manage workflow instances for tickets using ticket servicing system 305. Data processing system 300 maybe implemented in data processing system 100 in FIG. 1, data processing system 200 in FIG. 2, or anyone of servers 104 and 106 and clients 110, 112, and 114 in FIG. 1.

Ticket servicing system 305 receives query 307 from organization 312. Organization 312 may be any entity that includes two or more individuals, such as a corporation, partnership, association, department, governmental agency, or tenants in a common building. In the non-limiting example shown in FIG. 3, organization 312 includes upper tier employees 315 and lower tier employees 317. Upper tier employees 315 include senior employees that rank higher than lower tier employees 317 in organization 312. For example, upper tier employees 315 may include managers and other employees with a supervisory capacity. The lines connecting upper tier employees 315 and lower tier employees 317 to and amongst each other illustrate the hierarchical structure of the employees in organization 312.

Organization 312 may employ a network data processing system, such as network data processing system 100 in FIG. 1. For example, each of upper tier employees 315 and lower tier employees 317 may be clients, such as clients 110, 112, and 114 in FIG. 1, to a server, such as servers 104 and 106 in FIG. 1, within or without organization 312. In addition, each of upper tier employees 315 and lower tier employees 317 may be connected to one another via a network data processing system via respective data processing systems, such as data processing system 200 in FIG. 2. Non-limiting examples of data processing systems that may be employed by upper tier employees 315 and lower tier employees 317 to connect to a network data processing system include desktop computers, laptop computers, and personal digital assistants.

Query 307 from organization 312 may be any issue for which a workflow may be used to address. For example, query 307 may be a request for service to the network data processing system connecting upper tier employees 315 and lower tier employees 317. In this example, query 307 may stem from a malfunction or absence of any component of the network data processing system. Query 307 may also be requested from any one of upper tier employees 315 and lower tier employees 317 for a change of one or more of the components of the network data processing system. In another example, query 307 may be a request for service to any of the respective data processing systems used by each of upper tier employees 315 and lower tier employees 317, such as a respective employee's desktop computer, laptop computer, or personal digital assistant.

Query 307 to ticket servicing system 305 is not limited to queries of a technical nature. For example, query 307 may relate to a personnel matter, a client matter, a production matter, or any other matter concerning organization 312 for which a workflow may be used.

Ticket servicing system 305 may also receive query 320 from set of customers 323. Set of customers 323 includes customers 325 and 327. Although set of customers 323 includes two customers 325 and 327, set of customers 323 may include any number of customers.

Any of set of customers 323 may submit query 320 to ticket servicing system 305. Query 320 may pertain to any issue originating from any of set of customers 323 that may be addressed using a workflow. In one example, ticket servicing system 305 is a part of organization 315. In this example, organization 315 may provide technical support to set of customers 323 by receiving technical requests from set of customers 323 and addressing each request using ticket servicing system 305 and the workflows therein.

Each of set of customers 323 may also be clients, such as clients 110, 112, and 114 in FIG. 1, which are connected to one or more servers, such as servers 104 and 106 in FIG. 1, via a network such as network 102 in FIG. 1. The servers may be administered by organization 312. Query 320 from set of customers 323 may pertain to problems and issues regarding the network or the client computing devices being used by set of customers 323 for connection to the network. For example, query 320 may be a request for service from any of set of customers 323 that is unable to connect to the network. Query 320 may also be a request for a new computing device or other technical equipment, such as a desktop computer, laptop computer, or personal digital assistant.

Ticket servicing system 305 may be external or internal to organization 312. For example, ticket servicing system 305 may be administered by an entity that is separate from both organization 312 and set of customers 323, and which manages queries and other issues for organization 312 and set of customers 323. In another example, ticket servicing system 305 may be administered by an individual or department of organization 312. In this example, the individual or department administering ticket servicing system 305 may manage queries and other issues that originate from within organization 312, from set of customers 323, or from any other source that could potentially submit queries and issues.

Ticket servicing system 305, which receives queries 307 and 320 from organization 312 and set of customers 323, respectively, includes service desk application 330. Service desk application 330 manages one or more tickets that may correspond to the queries that are submitted to ticket servicing system 305. In one example, service desk application 330 may be Unicenter® Service Desk from CA®, Inc.

Service desk application 330 includes workflow application 335. In one example, workflow application 335 is integrated with service desk application 330, and may be used as one of several tools available to service desk application 330. Workflow application 335 manages workflows and executes workflow instances that may be used to address problems and issues, such as the problems and issues associated with queries 307 and 320. In one example, workflow application 335 may be CA® Workflow.

Upon receiving a query, such as queries 307 and 320, service desk application 330 may generate or open a ticket associated with the received query. Ticket 340 maybe

generated or opened automatically by service desk application 330 upon receiving the query, or may also be manually opened using service desk application 330.

Upon generating or opening ticket 340 in service desk application 330, workflow application 335 generates or opens workflow instance 343. Workflow instance 343 describes, in a workflow format, a set of activities that address the issue or solve the problem posed by a query from organization 312 or set of customers 323. Additional details regarding the format and structure of a workflow instance is provided in FIG. 4.

Workflow instance 343 may also be modified in workflow application 335. For example, a user that is executing workflow instance 343 may modify workflow instance 343 to better address a query or achieve any other desired objectives. In this example, a user may add or delete activities or steps, change the actors associated with the activities or steps, change the speed at which the activities or steps are performed, or perform any other modifications to workflow instance 343 allowable by workflow application 335. The modification of workflow instance 343 may occur in an Integrated Design Environment of CA® Workflow. In one non-limiting example, the user may be an employee of a department that utilizes ticket servicing system 305 or is otherwise capable of using workflow application 335.

Workflow application 335 also manages executing workflow instances, such as workflow instance 343. For example, workflow application 335 may facilitate the termination and initiation of workflow instances.

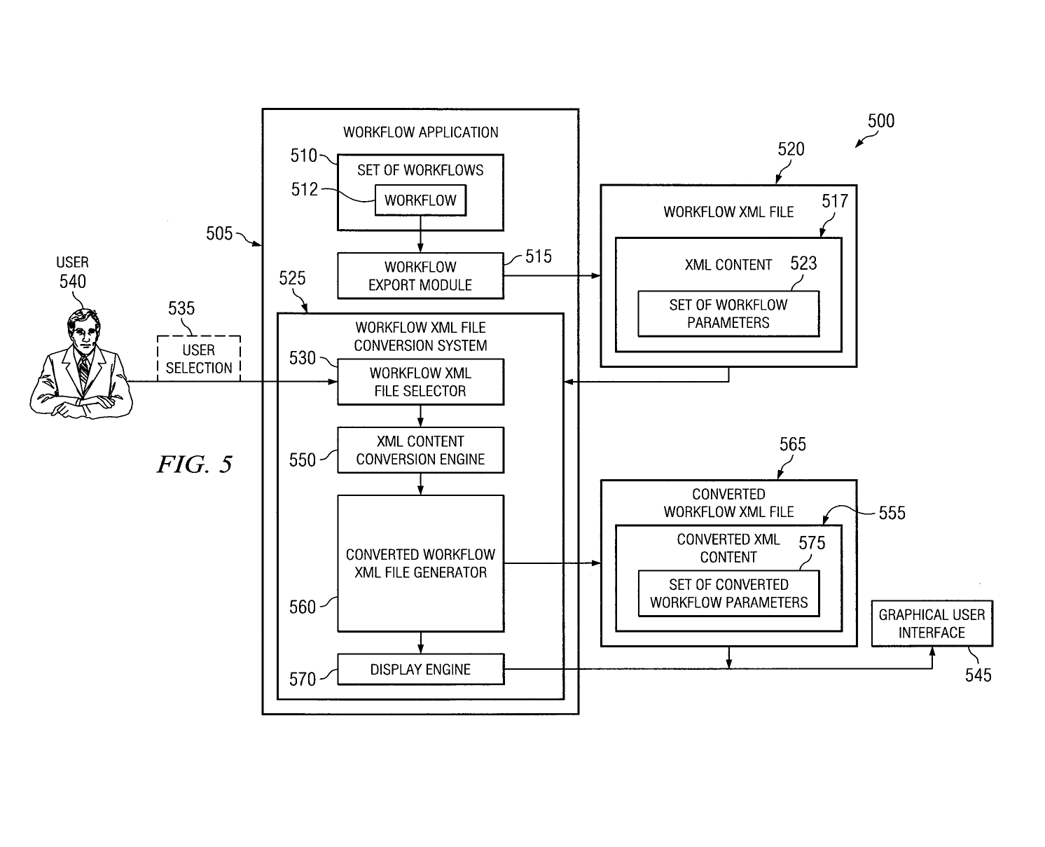

In addition, a workflow in workflow application 335 may be exported to XML content to form a workflow XML file. The XML content in the XML file may then be converted into a new format, and the newly formatted content may be included in a converted workflow XML file generated by workflow application 335. Additional details regarding the generation of converted workflow XML files will be provided in FIGS. 5-11 below.

Turning now to FIG. 4, a diagram of a workflow is depicted with which the illustrative embodiments may be implemented. Specifically, FIG. 4 shows workflow 400, which is an example of workflow instance 343 in FIG. 3.

Workflow 400 includes start node 405, nodes 410, 415, 420, 425, 430, and 435, and end node 440. Each of the nodes performs one or more activities that facilitate the objective of workflow 400. In addition, one or more actors, such as a human being, machine, or application, may perform each of the activities represented by each of the nodes.

By way of example to illustrate a workflow, the objective of workflow 400 may be to facilitate an equipment change request in response to a request from an employee outside of the IT department to change a piece of equipment, such as a desktop computer. In this example, the activity associated with node 410 may be to send an e-mail to a supervisor in the IT department requesting the supervisor's approval of the desktop computer change request. The activity associated with node 415 may be to decide whether to grant the change request based on the response of the IT supervisor. If the IT supervisor grants the change request, an e-mail may be sent to the requesting employee notifying the employee of the approval at node 420. On the other hand, if the IT supervisor denies the change request, an e-mail may be sent to the requesting employee notifying the employee of the denial at node 425. Node 430 may then merge the approval and denial routes to continue with the workflow. Node 435 may then change the status of the change request to reflect whether the change request was approved or denied.

Workflow 400 may also be edited using a workflow application, such as workflow application 335 in FIG. 3. For example, in the case in which workflow 400 is a workflow in CA® Workflow, start node 405, nodes 410, 415, 420, 425, 430, and 435, and end node 440 may be deleted, moved, or otherwise modified in an Integrated Design Environment. Additional nodes may also be added to workflow 400. The flow of workflow 400, as indicated by the lines connecting the nodes, may also be modified using the Integrated Design Environment of CA® Workflow.

Turning now to FIG. 5, a diagram of a system for generating a converted workflow extensible markup language file associated with a workflow application is depicted in accordance with an illustrative embodiment. Specifically, FIG. 5 shows data processing system 500, which contains components for terminating workflow instances in a workflow application. Data processing system 500 maybe implemented in data processing system 100 in FIG. 1, data processing system 200 in FIG. 2, or any one of servers 104 and 106 and clients 110, 112, and 114 in FIG. 1.

Data processing system 500 includes workflow application 505. Workflow application 505 is a non-limiting example of workflow application 335 in FIG. 3. In one example, workflow application 507 is CA® Workflow.

Workflow application 505 includes set of workflows 510. Set of workflows 510 may include any number of workflows. Workflow 400 in FIG. 4 is a non-limiting example of the workflows that maybe included in set of workflows 510.

Workflow application 515 also includes workflow export module 515. Workflow export module 515 exports workflows from set of workflows 510 from workflow application 505. In the non-limiting example of FIG. 5, workflow export module 515 exports workflow 512 in set of workflows 510 into XML content 517 to form workflow XML file 520.

XML content 517 contains XML code and describes or otherwise pertains to workflow 512. For example, XML content 517 includes set of workflow parameters 523. Set of workflow parameters 523 includes one or more workflow parameters. A workflow parameter is any attribute or data pertaining to workflow 512. For example, set of workflow parameters 523 may include an input parameter, an output parameter, a modified date, a process definition identifier, a process name, a short name, a description, and a number of nodes in the workflow. An input parameter is any input that may be accepted by workflow 512, including any data about the input. An output parameter is any output that may be generated by workflow 512, including any data about the output. A modified date parameter is a time at which workflow 512 was last modified. The process definition identifier parameter identifies workflow 512. The process name includes a name for workflow 512. The short name parameter includes a short name of workflow 512. The description parameter includes a description of workflow 512. The number of nodes parameters indicates a number of nodes in workflow 512.

In another embodiment, workflow export module 515 may export workflow 512 into a file that uses a computer language other than XML. Non-limiting examples of such languages include hypertext markup language, extensible hypertext markup language, or standard generalized markup language.

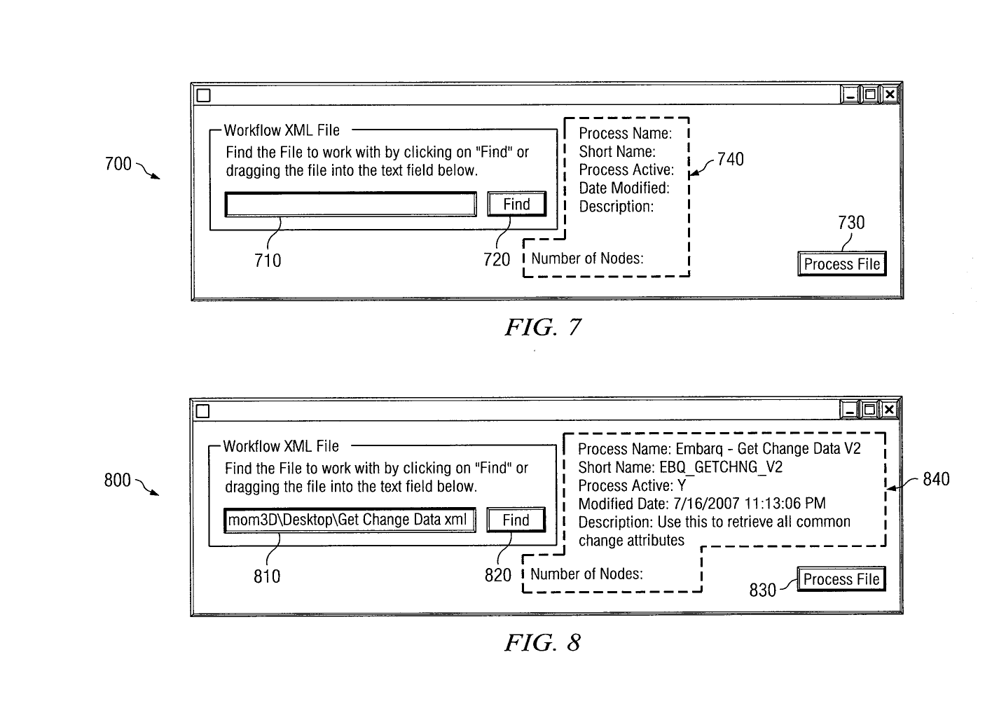

Workflow application 505 includes workflow XML file conversion system 525. In one embodiment, workflow XML file conversion system 525 identifies workflow XML file 520, which is associated with workflow 512. In one example of this embodiment, workflow XML file 520 may be identified using workflow XML file selector 530. Workflow XML file selector 530 receives user selection 535, which identifies workflow XML file 520. For example, workflow XML file selector 530 may display a dialog window to user 540 on graphical user interface 545 that includes a field into which user 540 may identify workflow XML file 520. Graphical user interface 545 is a non-limiting example of display 214 in FIG. 2. Additional details regarding such a dialog window will be provided in FIGS. 7 and 8 below.

Workflow XML file conversion system 525 also includes XML content conversion engine 550. XML content conversion engine 550 converts XML content 517 into a new format to form converted XML content 555. The new format may be programmed, created, or otherwise defined by any entity, such as user 540 or data processing system 500. For example, the new format may exclude XML commands, modify particular characters or words that were originally in XML content 517, or add characters or words that do not appear in XML content 517. However, the new format depends on the particular implementation of the illustrative embodiments.

Converted XML content 55 includes set of converted workflow parameters 575, which may include any of the set of workflow parameters 523 in the new format. For example, set of workflow parameters 523 may include, in the new format, the number of nodes of workflow 512. As explained further below, the parameters in set of workflow parameters 523 that are included in set of converted workflow parameters 575 may be selected by user 540 or data processing system 500 depending on the implementation.

In one example, XML content conversion engine 550, in converting XML content 517 into a new format to form converted XML content 555, converts at least one portion of XML content 517 that is associated with at least one workflow parameter in set of workflow parameters 523 into the new format to form set of converted workflow parameters 575. In this example, the workflow parameter(s) that are converted by XML content conversion engine 550 may be defined or otherwise selected by user 540 or data processing system 500. Thus, by selecting only particular workflow parameters in set of workflow parameters 523, only those portions of XML content 517 that pertain to the selected workflow parameters are converted into the new format.

In another embodiment, XML content conversion engine 550, in converting XML content 517 into a new format to form converted XML content 555, identifies a set of XML language lines in XL content 517. The set of XML language lines includes one or more XML language lines. In this embodiment, XML content conversion engine 550 also determines whether the set of XML language lines is associated with at least one workflow parameter in set of workflow parameters 523. In this example, the workflow parameter(s) in set of workflow parameters 523 may be defined or otherwise selected by user 540 or data processing system 500. XML content conversion engine 550, in response to determining that the set of XML language lines is associated with the workflow parameter(s), may convert the set of XML language lines into a new format to form a set of converted XML lines. These converted XML language lines, which include set of converted parameters 575, maybe included in converted XML content 555.

Workflow XML file conversion system 525 includes converted workflow XML file generator 560. Converted workflow XML file generator 560 generates converted workflow XML file 565, which includes converted XML content 555. In one example, converted workflow XML file 565 is a text file, which may have a file extension of .txt. However, converted workflow XML file 565 may be any type of file, such as Microsoft® Word files, WordPerfect files, Notepad files, or any other file type capable of storing text. Non-limiting examples of file extensions for such files include .doc, .rtf, or .wpd.

Workflow XML file conversion system 525 also includes display engine 570. Display engine 570 displays converted XML content 555 of converted workflow XML file 565 on graphical user interface 545 in the new format. For example, display engine 570 may display any of the set of converted workflow parameters 575, such as the number of nodes of workflow 512, on graphical user interface 545.

In another embodiment, display engine 570 may display any of the set of converted workflow parameters 575 in a dialog window. In one example, display engine 570 may display any of the set of converted workflow parameters 575 in the dialog window in which user selection 535 is made. Additional details regarding such a dialog window are provided in FIGS. 7 and 8 below.

In one example, workflow 512 is an updated workflow in a development server environment. In the development server environment, workflow application 505 may be tested and otherwise utilized by users that are developing workflow application 505. In this example, workflow XML file conversion system 525 may also form a separate converted XML file from a separate workflow in a production server environment. User 540, which in one example is a developer, may use the separate converted XML files from each server environment to implement changes made in workflow 512 to the workflow in the production server environment.

The illustrative embodiments provide user 540 with a displayable file that maybe more easily understandable. For example, converted workflow XML file 565 allows workflow parameters of workflow 512 to be more easily identified, understood, and implemented in other workflows, including workflows in different server environments.

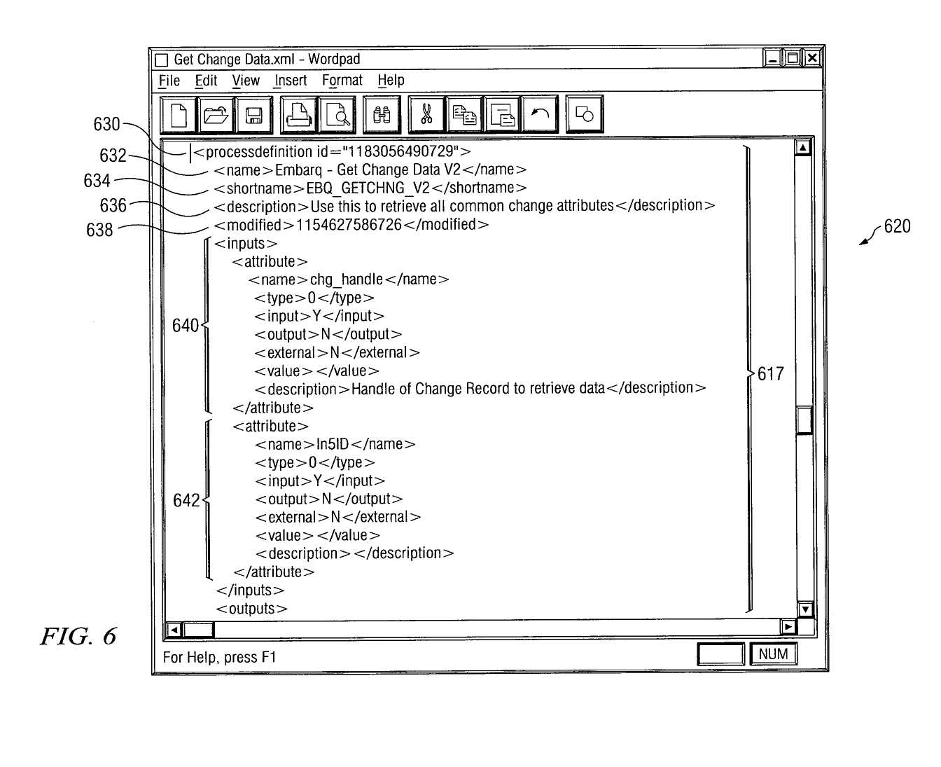

Turning now to FIG. 6, a graphical representation of an XML file is depicted in accordance with an illustrative embodiment. In particular, FIG. 6 shows workflow XML file 620, which is a non-limiting example of workflow XML file 520 in FIG. 5. The graphical representation of workflow XML file 620 is also a non-limiting example of a workflow XML file as viewed on a graphical user interface, such as graphical user interface 545 in FIG. 5.

Workflow XML file 620 includes XML content 617, which is a non-limiting example of XML content 517 in FIG. 5. XML content 617 includes multiple XML language lines, some of which include XML commands. XML content 617 includes multiple workflow parameters, which are examples of the parameters in set of parameters 523 in FIG. 5.

Included amongst the workflow parameters in XML content 617 are process definition identifier 630, process name parameter 632, short name parameter 634, description parameter 636, modified data parameter 638, and input parameters 640 and 642. Input parameters 640 and 642 also include XML code describing the input parameters, including the input parameter name, type, value, and description. Workflow XML file 620 may also include other workflow parameters not shown in FIG. 6.

Turning now to FIG. 7, a graphical representation of dialog window is depicted in accordance with an illustrative embodiment. In particular, FIG. 7 shows dialog window 700. Dialog window 700 is a non-limiting example of a dialog window that may be generated by a workflow XML file selector, such as workflow XML file selector 530 in FIG. 5. Dialog window 700 acts as an interface between a user and a workflow XML file conversion system, such as workflow XML file conversion system 525 in FIG. 5.

Dialog window 700 includes workflow XML file selector field 710. A user, such as user 540 in FIG. 5, may enter a user selection, such as user selection 535 in FIG. 5, into workflow XML file selector field 710 in order to select a workflow XML file. The text entered into workflow XML file selector field 710 may be a path or file name of a workflow XML file. A user may also select find button 720 in order to launch a process that facilitates finding the desired workflow XML file in a directory.

The workflow XML file entered into workflow XML file selector field 710 may then be converted by a workflow XML file conversion system, such as workflow XML file conversion system 525 in FIG. 5, in accordance with the illustrative embodiments by selecting process file button 730. Thus, a converted workflow XML file may be generated from the workflow XML file entered in workflow XML file selector field 710 by selecting process file button 730.

Dialog window 700 also contains workflow parameter fields 740. Workflow parameter fields 740 display parameters of the workflow XML file entered in workflow XML file selector field 710. In the non-limiting example of dialog window 800, workflow parameter fields 740 includes the process name parameter, short name parameter, process active parameter, modified date parameter, description parameter, and a number of nodes in the workflow.

Turning now to FIG. 8, a graphical representation of dialog window is depicted in accordance with an illustrative embodiment. In particular, FIG. 8 shows dialog window 800, which is a non-limiting example of dialog window 700 in FIG. 7.

In dialog window 800, a workflow XML file has been entered into workflow XML file selector field 810, which is a non-limiting example of workflow XML file selector field 710 in FIG. 7. The workflow XML file entered into workflow XML file selector field 810 corresponds to XML file 620 in FIG. 6.

Parameters for the workflow XML file entered in workflow XML file selector field 810 are displayed in workflow parameter fields 840, which are non-limiting examples of workflow parameter fields 740 in FIG. 7. In particular, the process name parameter, short name parameter, modified date parameter, and description parameter in workflow parameters fields 840 shows the values included in process name parameter 632, short name parameter 634, modified date parameter 638, description parameter 636 in FIG. 6, respectively. The number of nodes in the workflow corresponding to XML file 620 in FIG. 6 may also be shown in the number of nodes field in workflow parameters fields 840. The XML file may be converted into a converted XML file in accordance with the illustrative embodiments upon pressing process file button 830, which is a non-limiting example of process file button 730 in FIG. 7.

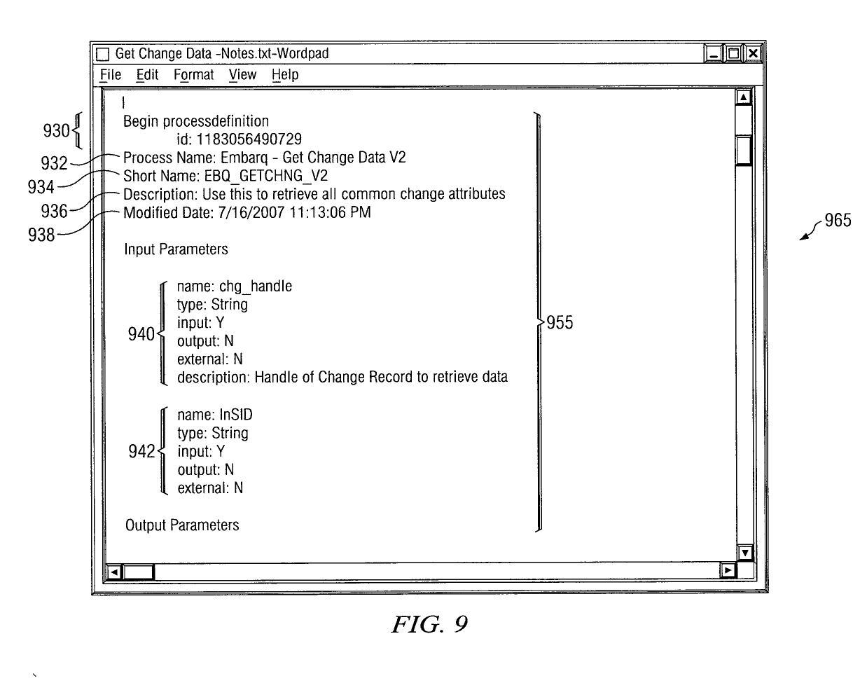

Turning now to FIG. 9, a graphical representation of a converted XML file is depicted in accordance with an illustrative embodiment. In particular, FIG. 9 shows converted workflow XML file 965, which is a non-limiting example of converted workflow XML file 565 in FIG. 5. Converted workflow XML file 965 is a non-limiting example of a converted workflow XML file that has been generated from workflow XML file 620 in FIG. 6 by a workflow XML file conversion system, such as workflow XML file conversion system 525 in FIG. 5. In the non-limiting example of FIG. 9, converted workflow XML file 965 is a text file, and may be viewed on a graphical user interface, such as graphical user interface 545 in FIG. 5.

Converted workflow XML file 965 includes converted XML content 955, which is a non-limiting example of converted XML content 555 in FIG. 5. Converted XML content 955 also includes multiple workflow parameters, which are examples of the parameters in set of converted workflow parameters 575 in FIG. 5. In the example of FIG. 9, each of the workflow parameters in converted XML content 955 corresponds to a workflow parameter in XML content 617 in FIG. 6. However, each of the workflow parameters in converted XML content 955 have a new format from the XML formatted workflow parameters in XML content 617 in FIG. 6. Specifically, the parameters of FIG. 6, including process definition parameter 930, process name parameter 932, short name parameter 934, description parameter 936, modified date parameter 938, and input parameters 940 and 942 show process definition parameter 630, process name parameter 632, short name parameter 634, description parameter 636, modified date parameter 638, and input parameters 640 and 642 in FIG. 6, respectively, are shown in a new format.

Converted XML content 955 allows a user, such as a developer, to more easily identify, understand workflow parameters in the workflow to which converted XML file 965 corresponds. These workflow parameters may then be implemented in the workflow to which converted XML file 965 corresponds, as well as other workflows. The illustrative embodiments, thus, eliminate the need for a developer to take manual notes of the changes made to a workflow so that those changes may be implemented in other workflows.

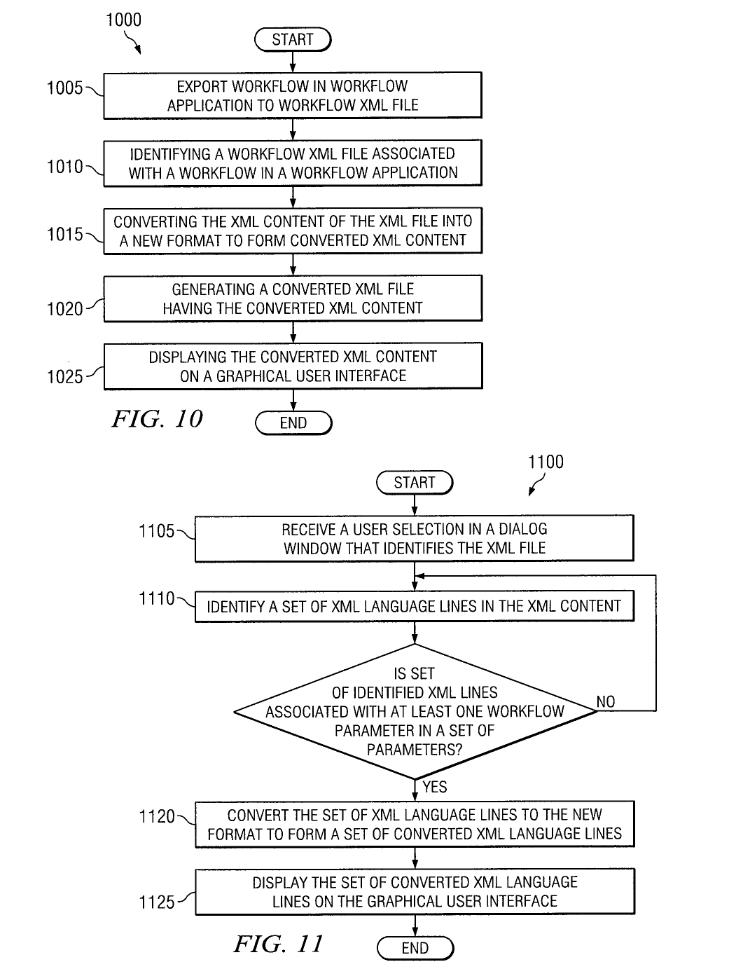

Turning now to FIG. 10, a flowchart illustrating a process for generating a converted workflow extensible markup language file associated with a workflow application is depicted in accordance with an illustrative embodiment. The process illustrated in FIG. 10 maybe implemented by a workflow application, such as workflow application 505 in FIG. 5.

The process begins by exporting a workflow in the workflow application into XML content to form a workflow XML file (step 1005). The process identifies a workflow XML file associated with the workflow in the workflow application, such as the exported workflow XML file from step 1005 (step 1010). The process converts the XML content of the workflow XML file into a new format to form converted XML content (step 1015). The process generates a converted XML file having the converted XML content (step 1020). The process displays the converted XML content on graphical user interface (step 1025). The process may then terminate.

Turning now to FIG. 11, a flowchart illustrating a process for generating a converted workflow extensible markup language file associated with a workflow application is depicted in accordance with an illustrative embodiment. The process shown in FIG. 11 maybe implemented by a workflow XML file conversion system, such as workflow XML file conversion system 525 in FIG. 5. The process shown in FIG. 11 also shows non-limiting details that may be included in steps 1010, 1015, 1020, and 1025 in FIG. 10.

The process begins by receiving a user selection in a dialog window that identifies the workflow XML file (step 1105). The process identifies a set of XML language lines in the XML content of the identified workflow XML file (step 1110). The process determines whether the set of identified XML lines is associated with at least one workflow parameter in a set of parameters (step 1115). In one example, the at least one workflow parameter is determined by a user.

If the process determines that the set of identified XML lines is not associated with at least one workflow parameter in a set of parameters, the process returns to step 1110. If the process determines that the set of identified XML lines is associated with at least one workflow parameter in a set of parameters, the process converts the set of XML language lines to the new format to form a set of converted XML language lines (step 1120). The process displays the set of converted XML language lines on a graphical user interface (step 1125). The process may then terminate.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the Figures. For example, in some cases, two blocks shown in succession may be executed substantially concurrently, or the blocks may sometimes be executed in the reverse order, depending upon the functionality involved.

The illustrative embodiments described herein provide a computer-implemented method, apparatus, and computer program product for generating a converted workflow extensible markup language file associated with a workflow application, such as the Workflow application from CA®, Inc. In one illustrative embodiment, the process identifies a workflow extensible markup language file associated with a workflow in a workflow application. The workflow extensible markup language file has extensible markup language content. The process converts the extensible markup language content into a new format to form converted extensible markup language content. The process generates a converted workflow extensible markup language file having the converted extensible markup language content. In one example, the converted extensible markup language file is a text file.

In one embodiment, the process displays the converted extensible markup language content on a graphical user interface in the new format. In one example of this embodiment, displaying the converted extensible markup language content on the graphical user interface in the new format may include displaying a number of nodes in the workflow.

In another embodiment, identifying the workflow extensible markup language file associated with the workflow in the workflow application includes receiving a user selection identifying the workflow extensible markup language file. In one example of the embodiment, the user selection is made in a dialog window, and at least one workflow parameter is displayed in the dialog window.

In another embodiment, the extensible markup language content includes a set of workflow parameters associated with the workflow. In this embodiment, converting the extensible markup language content into the new format to form the converted extensible markup language content may include converting at least one portion of the extensible markup language content that is associated with at least one workflow parameter in the set of workflow parameters into the new format. In one example of this embodiment, displaying the converted extensible markup language content on the graphical user interface in the new format may include displaying at least one workflow parameter on the graphical user interface in the new format. In one example, the set of parameters includes at least one of an input parameter, an output parameter, a modified date, a process definition identifier, a process name, a short name, a description, and a number of nodes in the workflow.

The principles of the present invention can take the form of an entirely hardware embodiment, an entirely software embodiment or an embodiment containing both hardware and software elements. In one embodiment, the invention is implemented in software, which includes but is not limited to firmware, resident software, microcode, and other computer readable code.

Furthermore, the principles of the present invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code may include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, and pointing devices) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed:

1. A method for generating a converted workflow extensible markup language file associated with a workflow application, comprising:
identifying a workflow extensible markup language file associated with a workflow in a workflow application, the workflow extensible markup language file having extensible markup language content;
converting the extensible markup language content into a new format to form converted extensible markup language content; and
generating a converted workflow extensible markup language file having the converted extensible markup language content.

2. The method of claim 1, further comprising:
displaying the converted extensible markup language content on a graphical user interface in the new format.

3. The method of claim 2, wherein displaying the converted extensible markup language content on the graphical user interface in the new format includes displaying a number of nodes in the workflow.

4. The method of claim 2, wherein the extensible markup language content includes a set of workflow parameters associated with the workflow, and wherein converting the extensible markup language content into the new format to form the converted extensible markup language content includes converting at least one portion of the extensible markup language content that is associated with at least one workflow parameter in the set of workflow parameters into the new format.

5. The method of claim 4, wherein identifying the workflow extensible markup language file associated with the workflow in the workflow application includes receiving a user selection identifying the workflow extensible markup language file.

6. The method of claim 5, wherein the user selection is made in a dialog window, and wherein the at least one workflow parameter is displayed in the dialog window.

7. The method of claim 4, wherein displaying the converted extensible markup language content on the graphical user interface in the new format includes displaying the at least one workflow parameter on the graphical user interface in the new format.

8. The method of claim 7, wherein the set of parameters includes at least one of an input parameter, an output parameter, a modified date, a process definition identifier, a process name, a short name, a description, and a number of nodes in the workflow.

9. The method of claim 7, wherein the at least one workflow parameter is defined by a user.

10. The method of claim 4, wherein converting the extensible markup language content into the new format to form the converted extensible markup language content further includes:
identifying a set of extensible markup language lines in the extensible markup language content;
determining whether the set of extensible markup language lines is associated with the at least one workflow parameter; and
responsive to determining that the set of extensible markup language lines is associated with the at least one workflow parameter, converting the set of extensible markup language lines into the new format to form a set of converted extensible markup language lines.

11. The method of claim 1, exporting the workflow from the workflow application into the extensible markup language content to form the workflow extensible markup language file.

12. The method of claim 1, wherein the workflow is an updated workflow in a development server environment, and wherein both converting and generating are performed on a separate workflow in a production server environment to form a separate converted extensible markup language file.

13. The method of claim 1, wherein the workflow application is Workflow from CA®, Inc.

14. The method of claim 1, wherein the converted extensible markup language file is a text file.

16. A system for generating a converted workflow extensible markup language file associated with a workflow application, comprising:
a workflow extensible markup language file selector, the workflow extensible markup language file selector identifying a workflow extensible markup language file associated with a workflow in a workflow application, the workflow extensible markup language file having extensible markup language content;
an extensible markup language content conversion engine, the extensible markup language content conversion engine converting the extensible markup language content into a new format to form converted extensible markup language content; and
a converted workflow extensible markup language file generator, the converted workflow extensible markup language file generator generating a converted workflow extensible markup language file having the converted extensible markup language content.

17. The system of claim 16, further comprising:
a display engine, the display engine displaying the converted extensible markup language content on a graphical user interface in the new format.

18. The system of claim 16, wherein identifying the workflow extensible markup language file associated with the workflow in the workflow application includes receiving a user selection identifying the workflow extensible markup language file.

19. The system of claim 16, wherein the converted extensible markup language file is a text file.

20. A data processing system comprising:
a bus system;
a memory connected to the bus system, wherein the memory includes a set of instructions; and
a processing unit connected to the bus system, wherein the processing unit executes the set of instructions to identify a workflow extensible markup language file associated with a workflow in a workflow application, the workflow extensible markup language file having extensible markup language content; convert the extensible markup language content into a new format to form converted extensible markup language content; and generate a converted workflow extensible markup language file having the converted extensible markup language content.
